(19) United States
(12) Patent Application Publication
(10) Pub. No.: US 2023/0247021 A1
(43) Pub. Date: Aug. 3, 2023

(54) VOICE VERIFICATION FACTOR IN A MULTI-FACTOR AUTHENTICATION SYSTEM USING DEEP LEARNING

(71) Applicant: Okta, Inc., San Francisco, CA (US)

(72) Inventors: Yu Wang, Toronto (CA); Catherine Razeto, Washington, DC (US); Pablo Terradillos, New York, NY (US); Alexander Kass, Hastings-on-Hudson, NY (US); Abhishek Ambastha, Toronto (CA)

(21) Appl. No.: 17/589,730

(22) Filed: Jan. 31, 2022

(51) Int. Cl. H04L 9/40

(52) U.S. Cl. CPC H04L 63/0861

(57) ABSTRACT

An authentication system supports multi-factor authentication (MFA) when authenticating the identity of a user. In particular, the authentication system includes voice analysis capabilities that allow voice to be one credential type available among the system's MFA capabilities. The authentication system can train a neural network-based voice model on a small number of sample utterances provided by a user as part of voice verification enrollment. The model is text-independent, such that the model can detect that spoken forms of different phrases represent the same voice, even though the phrases being spoken are different. To accomplish text-independent voice characteristics, the model derives embedding vectors from raw audio data that capture distinctive aural characteristics of the user's voice (such as pitch).

### FIELD OF ART

The present invention generally relates to the field of software systems, and more particularly, to incorporating voice verification as a factor in a multi-factor authentication system.

### BACKGROUND

Authentication systems authenticate the purported identity of a user wishing to gain access to a given electronic system. Multi-Factor Authentication (MFA) systems enhance security by requiring users to provide multiple different types of credentials (“factors”) before the MFA systems consider the user to be authenticated. For example, an MFA system could require—in addition to a standard credential such as a password—one or more of other types of credentials, such as biometric credentials (e.g., fingerprints), one-time passwords received through other channels, push notifications, or the like.

At the same time that an MFA system should be designed to be highly secure, however, the additional security should not unduly reduce the ease of use of the system. Certain types of credentials are more unwieldy for a user than others. For example, credential types that require possession of an object (e.g., USB tokens) are ineffective when the user does not happen to have the object readily available. Other credential types (such as certain biometric credentials) require additional hardware, such as specialized scanners, that many devices lack.

### SUMMARY

An authentication system supports multi-factor authentication (MFA) when authenticating the identity of a user. In particular, the authentication system includes voice analysis capabilities that allow voice to be one credential type available among the system's MFA capabilities. The authentication system can train a neural network-based voice model on a small number of sample utterances provided by a user as part of a voice verification enrollment phase. The model is text-independent, such that the model can detect that spoken forms of different phrases represent the same voice, even though the phrases being spoken are different. To accomplish text-independent voice characteristics, the model derives embedding vectors from raw audio data that capture distinctive aural characteristics of the user's voice (such as pitch).

The authentication system uses the voice model in a later verification phase, prompting the user to speak a phrase and then applying the voice model to the speech audio data to obtain an embedding vector, then comparing the embedding vector to the embedding already stored for the purported user, computing a degree of similarity between the two. The authentication system may further compare the embedding vector for the speech audio data to the embedding vectors for many other users, determining that the user's voice is verified only if the degree of similarity between the embedding vectors of the speech audio data and the embedding vector for the purported user is higher than some threshold number of degrees of similarity of the embedding vector to the embedding vectors of the other users. This determines that the spoken phrase sounds not only very like the speech of the purported user, but also much more like the speech of the purported user than like the speech of other users.

In some embodiments, the authentication system takes additional steps to ensure that the user's voice is properly verified and not subject to spoofing. For example, the authentication system may detect audio replay attacks by inferring the text of the speech to be verified using a speech-to-text algorithm and ensuring that this text matches the text that the user was prompted to speak. As another example, the authentication system can determine whether the user's speech is being spoken by a human, as opposed to being generated programmatically by a computer.

Thus, the authentication system supports voice verification within an MFA framework, voice being a simple type of credential for the user to supply during authentication and working on devices without specialized biometric hardware. The user may quickly enroll in voice verification by speaking only a few phrases, and the text-independence of the voice model used helps to prevent replay attacks, as does speech-to-text analysis to ensure that the spoken speech matches the text that was spoken. Attacks using computer-generated voices may also be prevented using a human speech recognition model.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF DRAWINGS

FIG. 1 illustrates one embodiment of a computing environment in which users use a client computing device to obtain access to authenticated resources over a network, according to some embodiments.

FIG. 2 is a high-level block diagram illustrating physical components of a computer used as part or all of (for example) the authentication system, the client device, and/or the resource server of FIG. 1, according to one embodiment.

The figures depict embodiments of the present invention for purposes of illustration only. One skilled in the art will readily recognize from the following description that alternative embodiments of the structures and methods illustrated herein may be employed without departing from the principles of the invention described herein.

### DETAILED DESCRIPTION

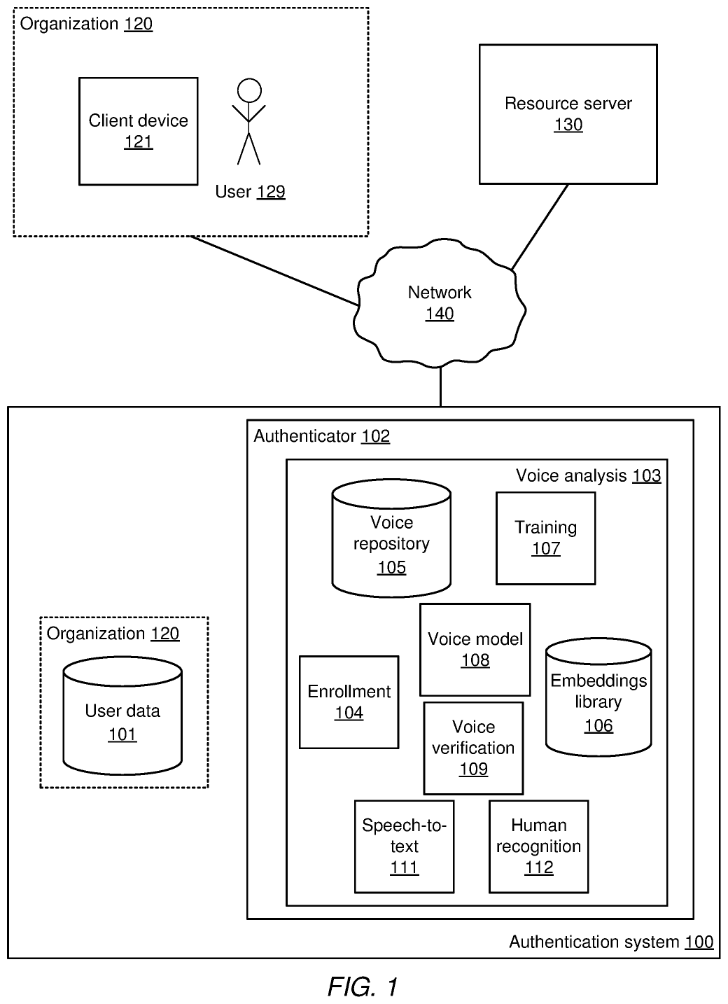

FIG. 1 illustrates one embodiment of a computing environment in which users use a client computing device to obtain access to authenticated resources over a network, according to some embodiments. The users are affiliated with an organization (e.g., employees or volunteers of the organization) and may access the resources on behalf of the organization. The users may have multiple accounts on different systems, and the resources that the users access may be owned and/or administered by different independent entities, such that the users may have a number of different identities—and corresponding credentials—across the different systems. The different accounts may provide the users with access to different resources, such as (for example) applications (e.g., email applications, timekeeping applications, spreadsheet applications, etc.), databases, file systems, or the like. Such applications could be, for example, entirely web-based and accessible through a web browser, or could be accessible through a native application installed on the user's client device and communicating with a remote application server. Since each application or other resource could be from a different provider—each of which could have a different identity for a user—a single user will typically have many different identities and associated credentials corresponding to the different resources that the user uses. However, for purposes of the invention, a user need only have a single account with a single corresponding identity.

An authentication system verifies the identities of users, ensuring that the user to be authenticated is indeed the specific user that the user is claiming to be (the “purported user”). If the user is successfully verified, the authentication system provides an authentication token that a resource server will accept as proof of their identities and hence of their permission to access requested resources. The authentication system may offer multi-factor authentication (MFA), such as one-time passwords (OTP), biometrics, or the like, in addition to a primary credential (e.g., a password). The entities of FIG. 1 are now described in more detail.

The organization 120 is an entity, such as a business, a school, a governmental agency, or the like, that has a number of affiliated users 129, such as employees or volunteers. One or more client devices 121 are registered to the users 129 by the organization 120 (or, in some embodiments, inferred from observation of past successful login patterns), and the users use the client devices 121 to access resources associated with the organization. Although for simplicity FIG. 1 illustrates only a single user 129 and client device 121, there may be any number of either.

The resource server 130 provides access to a resource, such as a web-based application (e.g., MICROSOFT OFFICE 365™), a service, a database, a document, or the like. The resource server 130 may be on a server separate from the systems of the authentication system 100 or the organization 120, or it may be part of any of the other systems. The resource server 130 requires authentication of users before the users may gain access to some or all of its resources, and (in embodiments in which the resource server 130 is independent of the authentication system 100) the resource server 130 accepts tokens of authentication from the authentication system 100 as establishing user identity.

The authentication system 100 authenticates the identity of the user 129, granting the user some proof of authentication, such as an authentication token, upon successful verification. The authentication system 100 stores user data 101 that include a set of identities of known users with accounts on the authentication system 100. The user data 101 may include a form of identity on the authentication system 100 such as a username, as well as other credential data associated with a user, such as a user password and/or information derived therefrom (such as an encrypted form of the password). The user data 101 may also include many other types of data about users, such as the credential types and providers that the users may use when seeking identity verification from the authentication system 100, their role(s) or group(s) within the organization 120 to which they belong (e.g., “Engineering”, “Legal”, “Manager 2”, “Director”, or the like), and/or the resources to which they have access (e.g., third-party applications such as SALESFORCE, MICROSOFT OFFICE 365, SLACK, or the like), as some examples. The user data 101 may also include identities and credentials of the various users on the various accounts to which they have access, thereby linking a user's identity on the authentication system 100 to the user's identities on those different accounts and (by extension) permitting access to those accounts. In some embodiments, the authentication system 100 is part of the organization 120, rather than being an independent entity as it is in other embodiments. In some embodiments, the authentication system 100 is a multi-tenant system, supporting multiple organizations 120 that serve as tenants of the system. In such embodiments, there is one instance of each of the organization-specific components (e.g., the user data 101) for each tenant organization.

In some embodiments, software on the client device 121 facilitates user authentication by securely and transparently communicating with the authentication system 100 that primarily handles the authentication, and by providing any resulting authentication tokens to a resource server 130 whose resources the user is attempting to access. In this way, the users of the organization 120 simply and securely obtain access to the resources that they need. Such software on the client device 121 may (although need not) be provided by the entity responsible for the authentication system 100. In some embodiments, the software is an authenticator application, a locally-installed application. In such embodiments, the authenticator application may have a graphical user interface that the user 129 uses to specify data used to authenticate the user to the authentication system 100. For instance, the authenticator application could display text fields or other data entry areas for specifying a username and password of the user 129, a drop-down list or other menu of types of MFA factors to use for authentication (e.g., biometrics such as voice verification, physical tokens, push notifications, or OTP), or the like. Based on the data and/or selections specified by the user 129 in the user interface, the authenticator application communicates with the authentication system 100 to authenticate the user on the authentication system 100. In other embodiments, the authenticator application is implemented as a plugin for another application.

Physically, the organization 120 is made up of a number of computing systems, including the various client devices 121; one or more internal networks that connects the computing systems, including routers or other networking devices that define the boundary between the organization and external networks; and the like.

Similarly, the authentication system 100, although depicted as a single logical system in FIG. 1, may be implemented using a number of distinct physical systems and the connections between them, such as application servers, database servers, load-balancing servers, routers, and the like.

The network 140 may be any suitable communications network for data transmission. In an embodiment such as that illustrated in FIG. 1, the network 140 uses standard communications technologies and/or protocols and can include the Internet. In another embodiment, the entities use custom and/or dedicated data communications technologies.

In some embodiments, the authentication system 100 includes single sign-on (SSO) functionality that—once the user has been authenticated—allows the authentication system to transparently log a user in to the different accounts or other resources to which the user has access. For example, for a given user who has logged in to the authentication system 100, the authentication system can look up the user's accounts or other resources within the user data 101, as well as the user's credentials for those accounts. Using the credentials, as well as metadata or other information about the accounts, authentication system 100 can automatically log the user into the applications or other resources described in the user data 101, such as by establishing application sessions with the various applications and providing corresponding session data (e.g., session tokens) to the device 121. Thus, with a single login to the authentication system 100, the SSO functionality of the authentication system provides a user with automatic access to all the user's accounts or other resources.

The authentication system 100 has an authenticator module 102 that handles the details of authenticating that a particular authentication request does indeed correspond to the purported user. In some embodiments, the authenticator module 102 supports multi-factor authentication (MFA), requiring that users using MFA provide not only a primary credential type (e.g., password), but also one or more secondary credential types. When a particular user requests authentication of the user's identity, the authenticator module 102 looks up the user in the user data 101 according to the user's purported identity (e.g., username), noting the credential types that the user is eligible to use for MFA. For example, if the purported user has previously been enrolled to use voice as a credential type (and an administrator has not disallowed its use), the authenticator module allows voice to be used as a verification option for the user during authentication.

In particular, the authenticator module 102 has a voice analysis module 103 that supports authentication using user voice as a credential type. The voice analysis module 103 enrolls a user, and then voice becomes available to that user as a credential type. Enrollment involves the user speaking a small number of phrases (e.g., three) as prompted by the voice analysis module 103. At runtime, during voice verification, the user again speaks a phrase prompted by the voice analysis module 103—which need not be the same as any of the phrases spoken during enrollment—and the voice analysis module 103 determines whether the user's voice when speaking this challenge phrase is sufficiently similar to the enrolled voice for the user, and sufficiently different from the enrolled voices of the other users of the system; if so, the user's voice is considered to be verified. Embeddings are derived for user speech using a neural network, resulting in a greater ability to compare voices. The voice analysis module 103 may also verify that the spoken challenge phrase matches the text of the challenge phrase, and/or that the spoken challenge phrase was spoken by a human, rather than generated by a computer. The components of the voice analysis module 103 are now described in additional detail.

The voice analysis module 103 stores, or accesses, a voice model 108 that can compute a degree of similarity between the audio data of two speech samples. The voice model 108 is a neural network with an embedding layer that reduces speech audio data to a fixed-size vector of real numbers, which aids in computing degrees of similarity of the audio data. In various embodiments, the neural network is a Long Short-Term Memory (LSTM), an attention-based neural network, or a transformer neural network.

In some embodiments, the voice module 103 generates the voice model 108 from known voice data. In such embodiments, the voice module stores a voice repository 105, which stores the audio data for a large number of phrases (e.g., thousands) uttered by different speakers, with approximately the same number of phrases for each speaker. The audio data for each phrase is labeled with a unique identifier of the user who uttered it to allow distinguishing the speakers' voices. A training module 107 takes the audio data and corresponding identifiers of the voice repository and trains the voice model 108 to predict which user the audio came from. The process for training that model involves generating an embedding for each audio clip, which is a vector representation of the audio. Embeddings from the same speaker are very similar. In some embodiments, triplet loss (comparing two sets of audio data for the same person, and two sets of audio data from a different person) is used as the loss function.

An enrollment module 104 obtains audio data for utterances of a user wishing to be enrolled in voice verification and generates embeddings that characterize the speech of that user. In some embodiments, the enrollment module 104 prompts the user to speak a small number of different utterances (e.g., three) for short prompt phrases (e.g., “This is my voice sample”, “South African penguins are adorable”, “The cow jumped over the moon”). The enrollment module may select the prompt phrases at random from a preexisting library of such phrases, or it may generate the phrases somewhat at random, e.g., as guided by a natural language grammar. The enrollment module 104 uses the voice model 108 to generate embeddings for the voice samples, storing a representative embedding within an embeddings library 106 in association with an identifier uniquely identifying the user. The embeddings may be treated in different ways in different embodiments. For example, in some embodiments the embedding for each voice sample is stored separately (and separately compared at time of voice verification to the voice sample to be verified); in other embodiments, for example, the embeddings are combined into a single embedding (e.g., through averaging). In some embodiments, if the voice samples do not have at least some threshold degree of similarity to the other voice samples (e.g., between every pair of voice samples), then the user is prompted for new voice samples.

The voice analysis module 103 further includes a voice verification module 109 that handles determinations at time of authentication of whether the audio data for a given utterance is sufficiently similar to the utterances uttered by the purported user during enrollment. More specifically, the voice verification module 109 uses the voice model 108 to compute embeddings of the given utterance and to compute a similarity score of those embeddings to the embeddings generated from the utterances of the purported user during enrollment and stored in the embeddings library 106. The similarity score may be computed as the cosine similarity of the vectors of the embeddings. The similarity computation varies according to the nature of the embeddings for the voice samples. For example, if there is a separate embedding for each voice sample, then there can be a similarity score for the embedding of the given utterance with each of the voice sample embeddings; if there is a single combined embedding for all the voice samples, the there is only one similarity score (between the embedding of the given utterance and single combined embedding).

In some embodiments, the voice verification module 109 additionally computes a similarity score of the given utterance with the embeddings of some (e.g., a random subsample) or all of the users in the embeddings library 106; this represents the various similarities given utterance to that of all the other enrolled users. In such embodiments, the user is authenticated as truly being the purported user if the similarity of the user's utterance to the utterances of the purported user during enrollment (as represented by the embeddings stored in the embeddings library for the purported user) is within the top similarities when comparing the user's utterance to the enrolled utterances of the other enrolled users. (What constitutes the “top” may be defined in different ways, such as in the top N percent (e.g., N=98).) That is, the given utterance must be highly similar to the known utterances of the purported users, relative to the similarities of the given utterance to the known utterances of other users. This allows a high degree of accuracy, while allowing for the fact that other users may also have very similar voices. When voice verification will be used as a secondary MFA factor, as opposed to the primary factor, more latitude may be given to the definition of the “top” (that is, the degree of required similarity may be lowered somewhat), since security in that situation is provided by the combination of the primary factor and the voice verification, and not solely by the voice verification. If multiple separate embeddings are stored for each user's voice samples, then there will be multiple similarity scores per user.

In some embodiments, the voice verification module 109 performs additional tests to further ensure that the user being verified is in fact the purported user. For example, in some embodiments the voice analysis module 103 includes a speech-to-text module 111 that the voice verification module 109 uses to verify that the phrase spoken by the user during voice verification matches the phrase that the voice analysis module 103 prompted the user to speak. (This protects against replay attacks, in which a malicious user plays back recorded speech of the purported user. This recorded speech has the same speech characteristics as the speech uttered by the purported user at enrollment—given that the speaker is the same—but is not original speech responding to the prompt phrase.) That is, the speech-to-text module 111 produces transcribed text from the utterance spoken during verification and compares it to the text of the prompt phrase, ensuring that there is at least some high threshold degree of similarity. If the degree of textual similarity is not sufficiently high, then the voice verification module 109 does not authenticate the user, even if the degree of audio similarity computed by using voice model 108 to compare embeddings is high.

In some embodiments, the voice analysis module 103 includes a human recognition module 112 that determines whether a given utterance was spoken by an actual human, as opposed to being generated programmatically by a text-to-speech algorithm. The human recognition module 112 uses a neural network trained on a positive training set of true utterances by humans and a negative training set of synthetic utterances produced using text-to-speech techniques. For example, the synthetic utterances could be produced by generative adversarial networks (GANs), and a binary classifier could be trained based on the true utterances and the synthetic utterances. If the human recognition module 112 determines that the utterance to be verified is below some threshold likelihood of having been spoken by a human, then the voice verification module 109 does not authenticate the user.

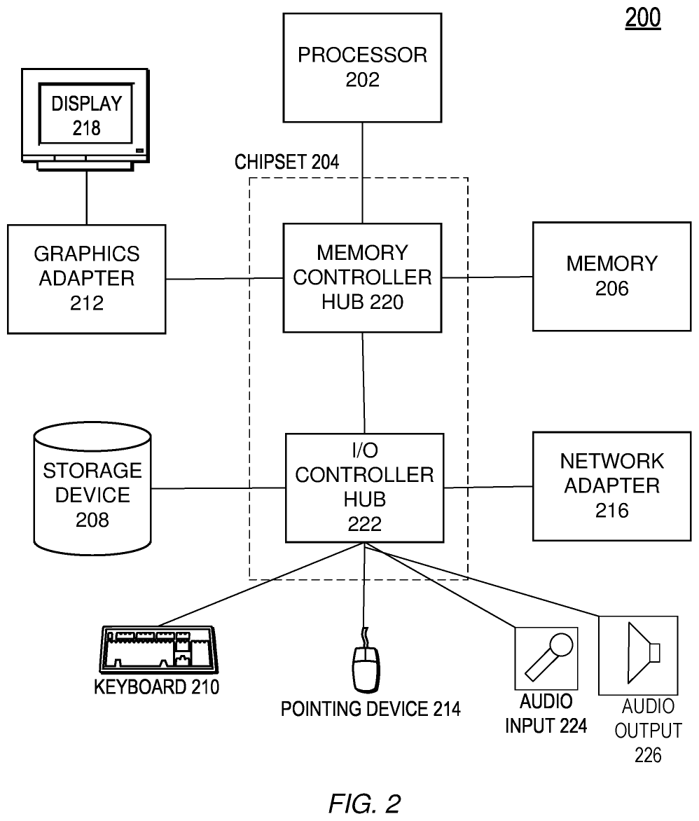

FIG. 2 is a high-level block diagram illustrating physical components of a computer 200 used as part or all of (for example) the authentication system 100, the client device 121, and/or the resource server 130 of FIG. 1, according to one embodiment. Illustrated are at least one processor 202 coupled to a chipset 204. Also coupled to the chipset 204 are a memory 206, a storage device 208, a graphics adapter 212, and a network adapter 216. A display 218 is coupled to the graphics adapter 212. In one embodiment, the functionality of the chipset 204 is provided by a memory controller hub 220 and an I/O controller hub 222. In another embodiment, the memory 206 is coupled directly to the processor 202 instead of the chipset 204.

The storage device 208 is any non-transitory computer-readable storage medium, such as a hard drive, compact disk read-only memory (CD-ROM), DVD, or a solid-state memory device. The memory 206 holds instructions and data used by the processor 202. The graphics adapter 212 displays images and other information on the display 218. The network adapter 216 couples the computer 200 to a local or wide area network. The keyboard 210 and point device 214 allow a user to manually provide input. The audio input (e.g., microphone) 224 and output (e.g., internal or external speaker) 226 provide the ability obtain sound input (e.g., for speech recognition) and produce sound output.

As is known in the art, a computer 200 can have different and/or other components than those shown in FIG. 2. In addition, the computer 200 can lack certain illustrated components. In one embodiment, a computer 200 acting as a server may lack a graphics adapter 212, and/or display 218, as well as a keyboard 210, pointing device 214, and/or audio input 224 and output 226. Moreover, the storage device 208 can be local and/or remote from the computer 200 (such as embodied within a storage area network (SAN)).

As is known in the art, the computer 200 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 208, loaded into the memory 206, and executed by the processor 202.

Embodiments of the entities described herein can include other and/or different modules than the ones described here. In addition, the functionality attributed to the modules can be performed by other or different modules in other embodiments. Moreover, this description occasionally omits the term “module” for purposes of clarity and convenience.

### OTHER CONSIDERATIONS

The present invention has been described in particular detail with respect to one possible embodiment. Those of skill in the art will appreciate that the invention may be practiced in other embodiments. First, the particular naming of the components and variables, capitalization of terms, the attributes, data structures, or any other programming or structural aspect is not mandatory or significant, and the mechanisms that implement the invention or its features may have different names, formats, or protocols. Also, the particular division of functionality between the various system components described herein is merely for purposes of example, and is not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a non-transitory computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of computer-readable storage medium suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the claims.

What is claimed is:

1. A computer-implemented method for voice-based authentication in a multi-factor authentication system, the computer-implemented method comprising:
an enrollment phase for voice verification, the enrollment phase comprising:
prompting a user to speak a plurality of textual phrases;
receiving, from the user, speech audio data for each of the textual phrases;
computing a first embedding vector for the speech audio data for the textual phrases;
a runtime verification phase comprising:
responsive to the user requesting access to a resource on a resource server, receiving a request to authenticate the user;
determining whether the user has enrolled in voice verification;
responsive to determining that the user has enrolled in voice verification:
providing the user with a selection of a plurality of credential types for verification, the plurality of credential types comprising a voice verification credential type;
receiving a selection of the voice verification credential type from the user;
prompting the user to speak a textual phrase different from any of the textual phrases of the enrollment phase;
receiving, from the user, speech audio data for the textual phrase;
computing a second embedding vector for the speech audio for the textual phrase;
computing a first similarity of the second embedding vector to the first embedding vector;
computing second similarities of the second embedding vector to embedding vectors of users other than the first user;
responsive at least in part to the first similarity being greater than a threshold number of the second similarities, determining that the user's voice is verified;
responsive at least in part to determining that the user's voice is verified, providing an authentication token for provision to the resource server for access to the resource.

2. A computer-implemented method for voice-based authentication, the computer-implemented method comprising:
a runtime verification phase comprising:
receiving a request to authenticate a user;
prompting the user to speak a textual phrase different from any textual phrase prompted during a prior enrollment phase in which the user was enrolled in voice verification and in which a first embedding vector was computed based on speech audio data of the user;
receiving, from the user, speech audio data for the textual phrase;
computing a second embedding vector for the speech audio for the textual phrase;
computing a similarity of the second embedding vector to the first embedding vector; and
responsive at least in part to the similarity being at least a threshold degree, determining that the user's voice is verified.

3. The computer-implemented method of claim 2, further comprising:
generating transcribed text by executing a speech-to-text algorithm on the speech audio for the textual phrase; and
determining whether the transcribed text is sufficiently similar to the textual phrase;
wherein determining that the user's voice is verified is responsive at least in part to determining that the transcribed text is sufficiently similar to the textual phrase.

4. The computer-implemented method of claim 2, further comprising:
determining, using a neural network on the speech audio for the textual phrase, whether the speech audio was spoken by a human;
wherein determining that the user's voice is verified is responsive at least in part to determining that the speech audio was spoken by a human.

5. The computer-implemented method of claim 2, further comprising:
during an enrollment phase for voice verification:
prompting the user to speak a plurality of textual phrases;
receiving, from the user, speech audio data for each of the textual phrases; and
computing the first embedding vector for the speech audio data for the textual phrases.

6. The computer-implemented method of claim 2, further comprising:
responsive at least in part to determining that the user' voice is verified, providing an authentication token for provision to a resource server for access to a resource.

7. The computer-implemented method of claim 2, further comprising:
identifying speech audio data of users other than the first user;
computing, for each of the other users, embedding vectors for speech audio of the user; and
computing second similarities of the second embedding vector to the embedding vectors of the users other than the first user;
wherein determining that the user's voice is verified is responsive at least in part to the similarity of the second embedding vector to the first embedding vector being greater than a threshold number of the second similarities.

8. A computer system comprising:
a computer processor; and
a non-transitory computer-readable storage medium storing instructions that when executed by the computer processor perform actions comprising:
a runtime verification phase comprising:
receiving a request to authenticate a user;
prompting the user to speak a textual phrase different from any textual phrase prompted during a prior enrollment phase in which the user was enrolled in voice verification and in which a first embedding vector was computed based on speech audio data of the user;
receiving, from the user, speech audio data for the textual phrase;
computing a second embedding vector for the speech audio for the textual phrase;
computing a similarity of the second embedding vector to the first embedding vector; and
responsive at least in part to the similarity being at least a threshold degree, determining that the user's voice is verified.

9. The computer system of claim 8, the actions further comprising:
generating transcribed text by executing a speech-to-text algorithm on the speech audio for the textual phrase; and
determining whether the transcribed text is sufficiently similar to the textual phrase;
wherein determining that the user's voice is verified is responsive at least in part to determining that the transcribed text is sufficiently similar to the textual phrase.

10. The computer system of claim 8, the actions further comprising:
determining, using a neural network on the speech audio for the textual phrase, whether the speech audio was spoken by a human;
wherein determining that the user's voice is verified is responsive at least in part to determining that the speech audio was spoken by a human.

11. The computer system of claim 8, the actions further comprising:
during an enrollment phase for voice verification:
prompting the user to speak a plurality of textual phrases;
receiving, from the user, speech audio data for each of the textual phrases; and
computing the first embedding vector for the speech audio data for the textual phrases.

12. The computer system of claim 8, the actions further comprising:
responsive at least in part to determining that the user' voice is verified, providing an authentication token for provision to a resource server for access to a resource.

13. The computer system of claim 8, the actions further comprising:
identifying speech audio data of users other than the first user;
computing, for each of the other users, embedding vectors for speech audio of the user; and
computing second similarities of the second embedding vector to the embedding vectors of the users other than the first user;
wherein determining that the user's voice is verified is responsive at least in part to the similarity of the second embedding vector to the first embedding vector being greater than a threshold number of the second similarities.
